(19) United States
(12) Patent Application Publication
(10) Pub. No.: US 2008/0298618 A1
(43) Pub. Date: Dec. 4, 2008

(54) Earpiece for a hearing apparatus with a securing ring

(75) Inventors: Joachim Baumann, Furth (DE); Klaus Breindl, Nurnberg (DE); Werner Fickweiler, Bubenreuth (DE); Anton Gebert, Kleinsendelbach (DE); Uli Gommel, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL INSTRUMENTS PTE., LTD.

(21) Appl. No.: 12/156,113

(22) Filed: May 29, 2008

Related U.S. Application Data
(60) Provisional application No. 60/932,526, filed on May 31, 2007.

(51) Int. Cl. H04R 25/00

(52) U.S. Cl. 381/325

(57) ABSTRACT

A cerumen protection system is to be held more securely in an earpiece of a hearing apparatus which can be worn in the ear. In particular, this is to be able to be ensured for the earpiece piece of an external receiver of a behind-the-ear hearing device. An earpiece with a sound exit opening and a cerumen protection facility which has an annular carrier and which is arranged in the sound exit opening, is provided, with the earpiece being manufactured from a rubbery-elastic material. A securing ring is also provided, which surrounds the sound exit opening, the inner diameter of which is smaller than the outer diameter of the carrier of the cerumen protection facility, which is less elastic than the earpiece and is fixedly integrated in the earpiece. The sound exit opening is thus reinforced so that the cerumen protection facility is not able to slide out thereof.

The present invention relates to an earpiece for a hearing apparatus which can be worn in the ear and comprises a sound exit opening and a cerumen protection facility, which has an annular carrier and which is arranged in the sound exit opening, with the earpiece being manufactured from a rubbery-elastic material. The term hearing apparatus is understood here to mean in particular a device which can be worn on the ear, such as for instance a hearing device, a headset, ear-phones and suchlike.

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. also concha hearing devices or completely-in-the-channel devices (CIC), are provided. The hearing devices listed by way of example are worn on the outer ear or in the auditory canal. Furthermore, bone conduction hearing aids, implantable or vibrotactile hearing aids are also available on the market. The damaged hearing is herewith either stimulated mechanically or electrically.

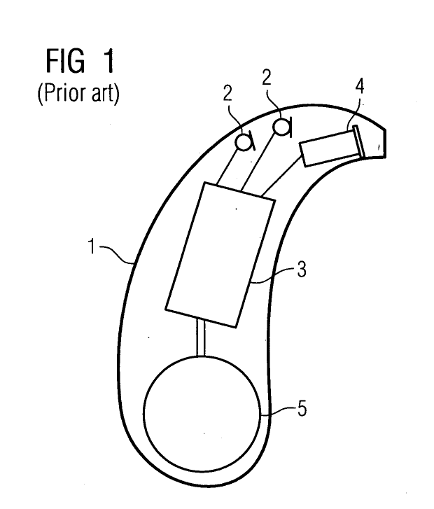

Essential components of the hearing devices include in principal an input converter, an amplifier and an output converter. The input converter is generally a receiving transducer, e.g. a microphone and /or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This main configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is supplied by a battery 5 which is likewise integrated into the hearing device housing 1.

With hearing devices which have a receiver in the canal (RIC), a cerumen protection system is installed in the earpiece of the receiver in the canal in a similar manner to ITE hearing devices. The cerumen protection system protects the receiver inserted into the earpiece (also called ear tip or dome) from cerumen, dirt and sweat. Said cerumen protection system is positioned at the sound exit opening in the sound path of the receiver in the earpiece.

In contrast to the fixed shell of ITE hearing devices, the material of the earpiece in RIC devices is flexible and soft. As a result, when inserting or removing the receiver into/out of the auditory canal for instance, the cerumen protection system consisting of a more solid material can be unintentionally removed from the sound exit opening of the soft earpiece and can enter into the auditory canal.

The cerumen protection system must essentially be replaced from time to time. To this end, it is removed from inside the earpiece which is withdrawn from the RIC housing and is replaced by a new cerumen protection system. The cerumen protection system is then held on the side facing the receiver by means of the RIC housing and is held on the side facing away from the receiver by means of molding the soft earpiece material. As described above, this soft material is however not always able to ensure that the cerumen protection system remains in the earpiece. The sound exit opening can instead gape open as a result of the high tensile strength and/or elasticity of the earpiece material and can release the cerumen protection system.

The object of the present invention thus consists in fastening the cerumen protection system more securely in the earpiece.

In accordance with the invention, this object is achieved by an earpiece for a hearing apparatus which can be worn in the ear and which comprises a sound exit opening and a cerumen protection facility, which has an annular carrier and which is arranged in the sound exit opening, with the earpiece being manufactured from a rubbery-elastic material, and also comprises a securing ring, which surrounds the sound exit opening, the inner diameter of which is smaller than the outer diameter of the carrier of the cerumen protection facility, which is less elastic than the earpiece and is fixedly integrated in the earpiece.

The less elastic securing ring advantageously prevents the cerumen protection system from outwardly leaving the sound exit opening. This possibility is at least significantly controlled by the fixed securing ring. This namely causes the tensile strength of the sound exit opening to reduce significantly so that the cerumen protection system is practically still only able to be removed from the earpiece in the backwards direction, i.e. toward the receiver.

The securing ring preferably consists of a plastic, a metal or a hard rubber. In the case of hard rubber, a certain elasticity can be retained, which is less common in the case of plastic rings and metal rings.

According to a special embodiment, the securing ring has an undercut, which holds it in the earpiece in a form-fit manner. This form-fit prevents a movement in the direction away from the receiver, i.e. out of the sound exit opening, if the earpiece has a corresponding shoulder.

The securing ring can also have a circular cross-section. Essentially any cross-sections of the securing ring are naturally conceivable, however standard designs such as a round, oval or rectangular cross-section are preferred.

It is particularly favorable if the securing ring is vulcanized into the earpiece. If the securing ring then consists of a suitable material, the securing ring chemically connects to the surrounding earpiece material during vulcanization. The securing ring is then correspondingly fixedly connected to the earpiece and/or is integrated therein.

In particular, the earpiece can be manufactured from silicon. This material proves to be particularly biocompatible and wear-resistant.

In a particularly advantageous application, the aforedescribed inventive earpiece is clipped onto an external receiver of a BTE hearing device. Hearing device wearers, who frequently remove from the ear and reinsert the external receiver of their hearing device, thus particularly benefit herefrom, with there being a risk each time however that with conventional earpieces without a securing ring, the sound exit opening expands so much that the cerumen protection system is forced out.

The present invention is now described in more detail on the basis of the appended drawings, in which;

FIG. 1 shows the basic design of a hearing device with its main components according to the prior art;

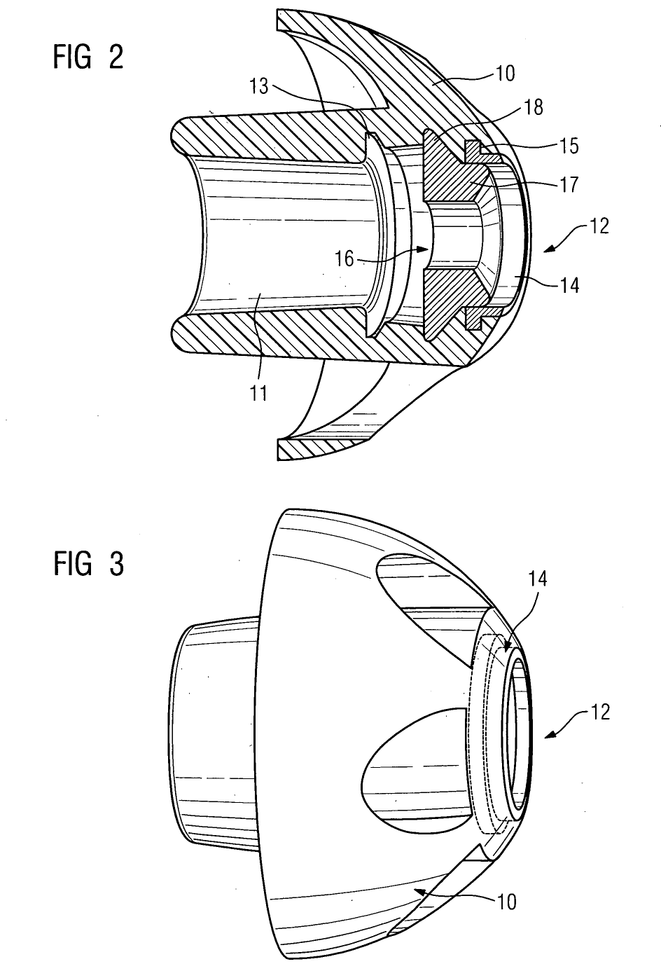

FIG. 2 shows a longitudinal section of an inventive earpiece with a vulcanized securing ring according to a first embodiment;

FIG. 3 shows a side view of the earpiece in FIG. 2;

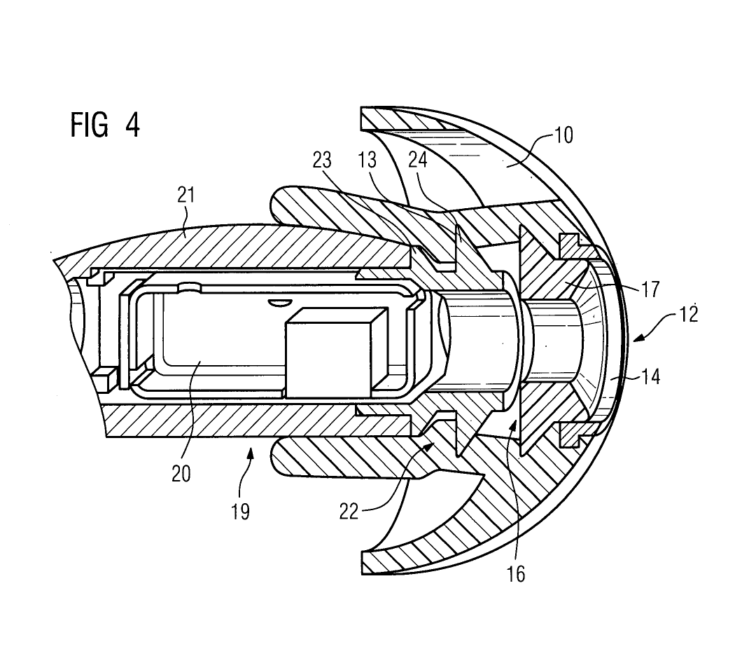

FIG. 4 shows a view of the longitudinal section of an external receiver, onto which the earpiece in FIG. 2 clips and

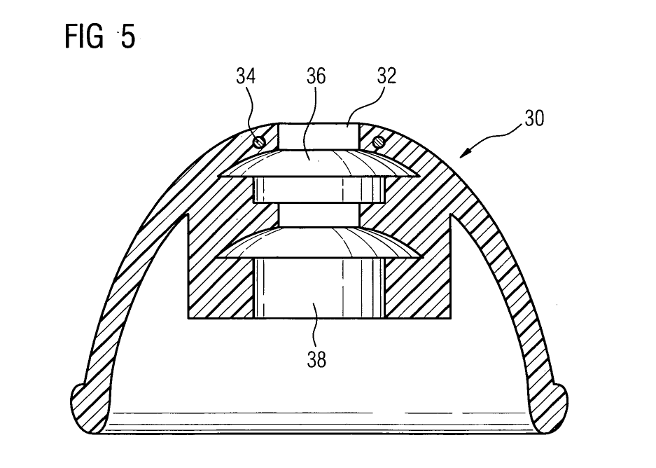

FIG. 5 shows an earpiece with a vulcanized securing ring according to a second embodiment.

The exemplary embodiments illustrated in more detail below represent preferred embodiments of the present invention.

The longitudinal section of the earpiece illustrated in FIG. 2 for a BTE hearing device with an external receiver is approximately mushroom-shaped and is made of silicon. The earpiece 10 is accordingly flexible and can be introduced into practically any auditory canal, without having to be specially adjusted thereto. A channel 11 runs inside the earpiece 10, into which channel an external receiver is inserted from the side of the base of the mushroom-shaped earpiece 10 (cf. FIG. 4) and which external receiver opens out into a sound exit opening 12. The channel 11 has an annular indentation 13, which is used to hold the external receiver.

As the earpiece in this example consists of elastic silicon, provision is made in accordance with the invention to prevent and/or minimize the deformability of the soft earpiece 10 to the sound exit opening 12. The flexibility of the earpiece 10 in the auditory canal which is required for the application and the comfortable position is also not negatively affected here. This is achieved by fixedly inserting a securing ring 14 into the soft material of the earpiece. The securing ring 14 can consist for instance of plastic, metal or hard rubber. In the present example, the securing ring 14 is vulcanized into the silicon of the earpiece 10. To this end, said securing ring 14 was placed in the vulcanization mold and baked together with the silicon. When suitably selecting the ring material, this connects chemically to the silicon of the earpiece during vulcanization.

To assist with the connection between the securing ring 14 and the earpiece 10, the securing ring 14 can have an undercut 15 and the earpiece 10 a corresponding shoulder, so that the securing ring 14 is also held in the earpiece 10 in a form-fit fashion. The securing ring 14 which is fixedly positioned in the earpiece 10 then also prevents the sound exit opening 12 from expanding when the earpiece 10 deforms and keeps a cerumen protection system 16 located therebehind in its position. This cerumen protection system 16 consists of a hard plastic ring as an annular carrier 17, the outer diameter of which corresponds approximately to the inner diameter of the securing ring 14. The cerumen protection system 16 has an outwardly protruding conical collar 18 on the side facing away from the sound exit opening 12, said collar 18 exceeding the inner diameter of the securing ring 14. Consequently, the cerumen protection system 16 cannot be forced through the securing ring 14. The securing ring 14 also prevents the sound exit opening from widening during the deformation of the earpiece 10 and thus keeps the cerumen protection system 16 in its position. For exchange purposes, the cerumen protection system 16 is to be removed backwards, in other words out of the earpiece 10 away from the sound exit opening 12. Attention should be paid to the fact that on the side facing toward the sound exit opening 12, the cerumen protection system 16 has a wafer-thin film on the annular carrier 17, which is not shown in FIG. 2. This represents the actual cerumen protection system and can be washed and/or cleaned.

FIG. 3 shows the silicon earpiece 10 from the outside. The securing ring 14, which surrounds the sound exit opening 12, can be easily recognized there.

FIG. 4 shows the earpiece in FIG. 2 in the state whereby it is clipped onto an external receiver 19. The external receiver 19 contains the actual converter 20, which is accommodated in a receiver housing 21. The receiver has a sound outlet connection 22 with securing tapered rings 23 and 24 which are formed in a single piece. While the one securing tapered ring 23 is used for support on the receiver housing 21, the second securing tapered ring 24 is used to hold the earpiece 10. To this end, it engages in the circumferential recess and/or indentation 13 of the earpiece 10. As a result, the earpiece 10 can still only be removed from the sound outlet connection 22 and/or the external receiver 19 with increased force. The cerumen protection system 16 is thus fixed (as far as possible) in an axial direction between the sound outlet connection 22 and the securing ring 14 when the earpiece 10 is clipped onto the external receiver 19.

A further embodiment of the inventive earpiece is shown in a longitudinal section in FIG. 5. The earpiece 30 is again approximately mushroom-shaped, with the base of the mushroom here being somewhat shortened. The sound exit opening 32 is also surrounded here by a securing ring 34 which is less elastic by comparison with the earpiece 30. Unlike the preceding exemplary embodiment, this has however a circular cross-section design and is completely embedded into the earpiece material. It has the same function as in the preceding exemplary embodiment, since it reinforces the sound exit opening 32 and prevents the cerumen protection system 36 from unintentionally slipping out of the earpiece 30. The external receiver is only shown here with its sound outlet connection 38, which is clipped onto the side in the earpiece 30 which faces the sound exit opening 32.

The above embodiments show that the securing ring 14, 34 can be vulcanized into the earpiece 10, 30, if the earpiece 10, 30 is manufactured from silicon for instance. If by contrast the earpiece is injection-molded from a different plastic, accordingly there is the possibility of injection-molding the securing ring around the sound opening. Furthermore, the securing ring can also be subsequently glued into a corresponding recess of the earpiece at the sound exit opening. The ring then also forms the required fixed, non-detachable compound with the earpiece material. In any case, the rear mountability of the cerumen protection system is still also guaranteed.

1.-7. (canceled)

8. An in-the-ear hearing device, comprising:
an earpiece;
a sound exit opening that is arranged in the earpiece;
a cerumen protection unit that is arranged in the sound exit opening and has an annular carrier; and
a securing ring that surrounds the sound exit opening and is fixedly integrated in the earpiece,
wherein the securing ring is configured to have a smaller inner diameter than an outer diameter of the annular carrier and less elastic than the earpiece.

9. The in-the-ear hearing device as claimed in claim 8, wherein the earpiece is manufactured from a rubbery-elastic material.

10. The in-the-ear hearing device as claimed in claim 9, wherein the rubbery-elastic material is silicon.

11. The in-the-ear hearing device as claimed in claim 8, wherein the securing ring is manufactured from a material selected from the group consisting of: a plastic, a metal, and a hard rubber.

12. The in-the-ear hearing device as claimed in claim 8, wherein the securing ring comprises an undercut.

13. The in-the-ear hearing device as claimed in claim 12, wherein the securing ring is held in the earpiece form-fitly by the undercut.

14. The in-the-ear hearing device as claimed in claim 8, wherein the securing ring comprises a circular cross-section.

15. The in-the-ear hearing device as claimed in claim 8, wherein the securing ring is vulcanized into the earpiece.

16. A behind-the-ear hearing device, comprising:
an external receiver;
an earpiece that is clipped to the external receiver;
a sound exit opening that is arranged in the earpiece;
a cerumen protection unit that is arranged in the sound exit opening and has an annular carrier; and
a securing ring that surrounds the sound exit opening and is fixedly integrated in the earpiece,
wherein the securing ring is configured to have a smaller inner diameter than an outer diameter of the annular carrier and less elastic than the earpiece.

17. A method for fastening a cerumen protection unit of a hearing device to an earpiece of the hearing device, comprising:
providing a sound exit opening in the earpiece;
arranging the cerumen protection unit in the sound exit opening;
providing a securing ring having a smaller inner diameter than an outer diameter of an annular carrier of the cerumen protection unit and less elastic than the earpiece;
surrounding the sound exit opening by the securing ring; and
fixedly integrating the securing ring in the earpiece.
